(19) United States
(12) Patent Application Publication
(10) Pub. No.: US 2017/0057062 A1
(43) Pub. Date: Mar. 2, 2017

(54) HAMMER ASSEMBLY OF A POWER TOOL

(71) Applicant: YI-JOU WANG, Taichung City (TW)

(72) Inventor: YI-JOU WANG, Taichung City (TW)

(21) Appl. No.: 15/226,198

(22) Filed: Aug. 2, 2016

(30) Foreign Application Priority Data
Aug. 28, 2015 (TW) 104128415

(51) Int. Cl. B25B 21/02

(52) U.S. Cl. CPC B25B 21/02

(57) ABSTRACT

A hammer assembly of a power tool is provided, including: a main body, defining an axial direction and a radial direction, having a receiving room opened radially and having two saddle portions by two opposite sides of the receiving room, the two saddle portions respectively having an assembling end and a through hole communicating with the receiving room; an axle, disposed through the through hole axially into the receiving room and rotatably assembled to the main body; a hammer block, laterally movably and circumferentially swingably assembled to the main body, the hammer block received in the receiving room and swingably saddled around the axle; wherein when the main body is driven by the power source to rotate, the hammer block comoves with the main body and impacts and drives the axle intermittently.

### BACKGROUND OF THE INVENTION

Field of the Invention

The present invention relates to a hammer block, and more particularly to a hammer assembly of a power tool.

Description of the Prior Art

Most of conventional rotational impact tools use a pneumatic motor to drive a hammer assembly to rotate, the hammer assembly has a mechanism which can produce an impacting power, for example, a hammer block or an impacting rack, and a front end of the hammer assembly exports a rotational power with an impacting effect. Tools of this type are disclosed in, for example, TWM379496 and TWM399005.

In this type of conventional tool, two inserting pins are inserted in two sides of the hammer block to form the hammer assembly, the hammer block is swingable about the inserting pin, a swinging range of the hammer block is restricted so as to control a motion of the hammer block, and the hammer block impacts an axle to produce the impacting power. However, when the hammer assembly rotates the hammer block, the hammer assembly impacts the axle and produces a great rotational and flinging inertia; and the hammer block heavily impacts an inner wall of a hammer room and makes the whole tool vibrate greatly; therefore, the conventional tool cannot rotate stably and operate precisely and is unfavorable to be operated for a long time, and an impacting torque and a transmission efficiency of the pneumatic tool and a service life of the hammer assembly are decreased.

The present invention has arisen to mitigate and/or obviate the afore-described disadvantages.

### SUMMARY OF THE INVENTION

The major object of the present invention is to provide a hammer assembly of a power tool which can prevent the imbalance situation from happening when the hammer assembly of a power tool is impacted and flung to rotate and can further achieve a preferable dynamic balance and rotational balance and increase a precision and a duration of the operation.

To achieve the above and other objects, a hammer assembly of a power tool is provided, including a main body, defining an axial direction and a radial direction, the main body having a receiving room opened radially and having two saddle portions by two opposite sides of the receiving room in the axial direction, the two saddle portions respectively having an assembling end for being connected to a power source of a power tool and a through hole communicating with the receiving room in the axial direction; an axle, disposed through the through hole axially into the receiving room and rotatably assembled to the main body; a hammer block, laterally movably and circumferentially swingably assembled to the main body, the hammer block received in the receiving room and swingably saddled around the axle; wherein when the main body is driven by the power source to rotate, the hammer block comoves with the main body and impacts and drives the axle intermittently.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown view of the preferred embodiment of the present invention;

FIG. 3 is a cross-sectional view of the preferred embodiment of the present invention; and

FIGS. 4 to 7 are drawings showing the preferred embodiment of the present invention in operation.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

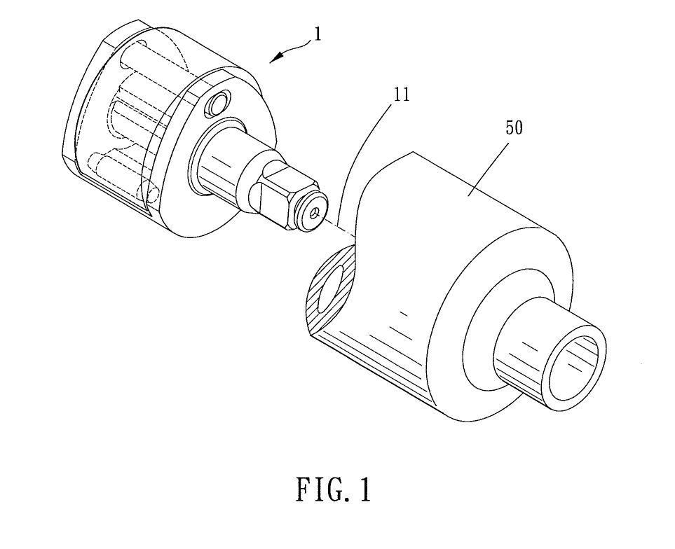

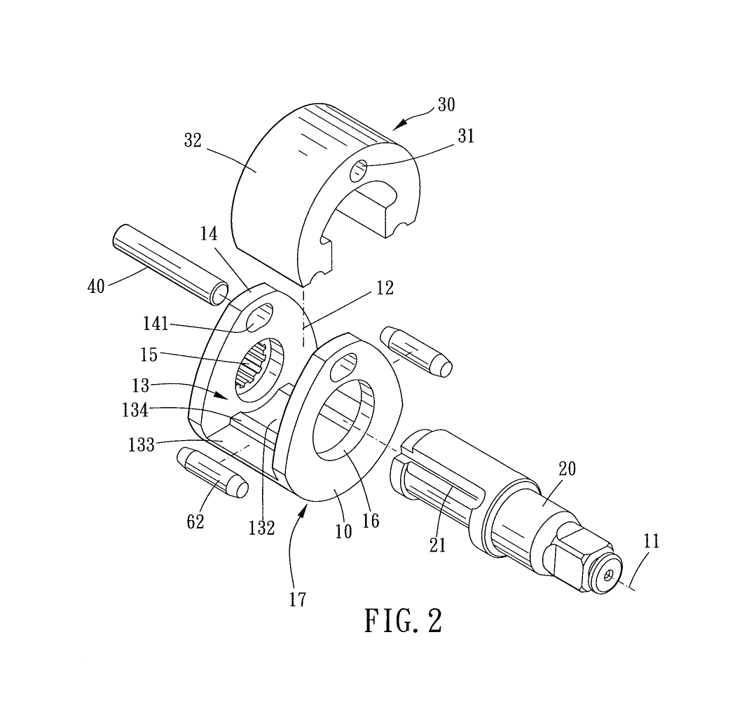

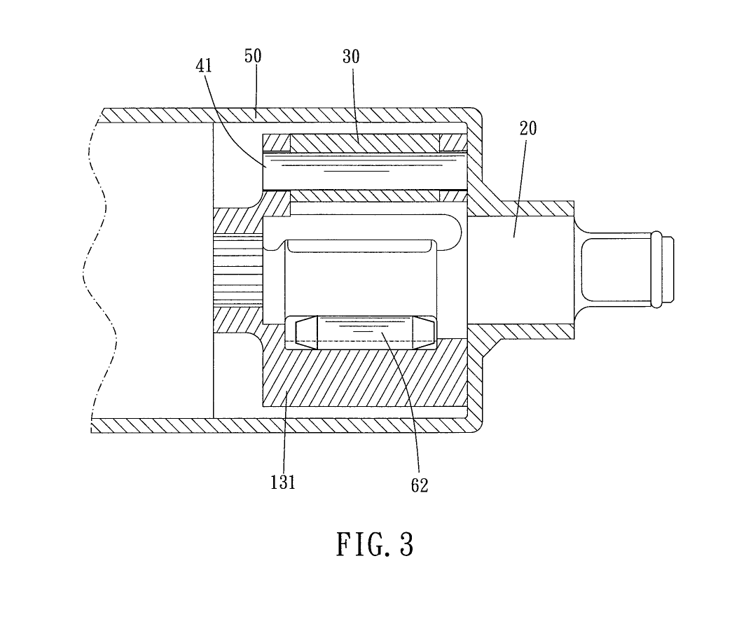

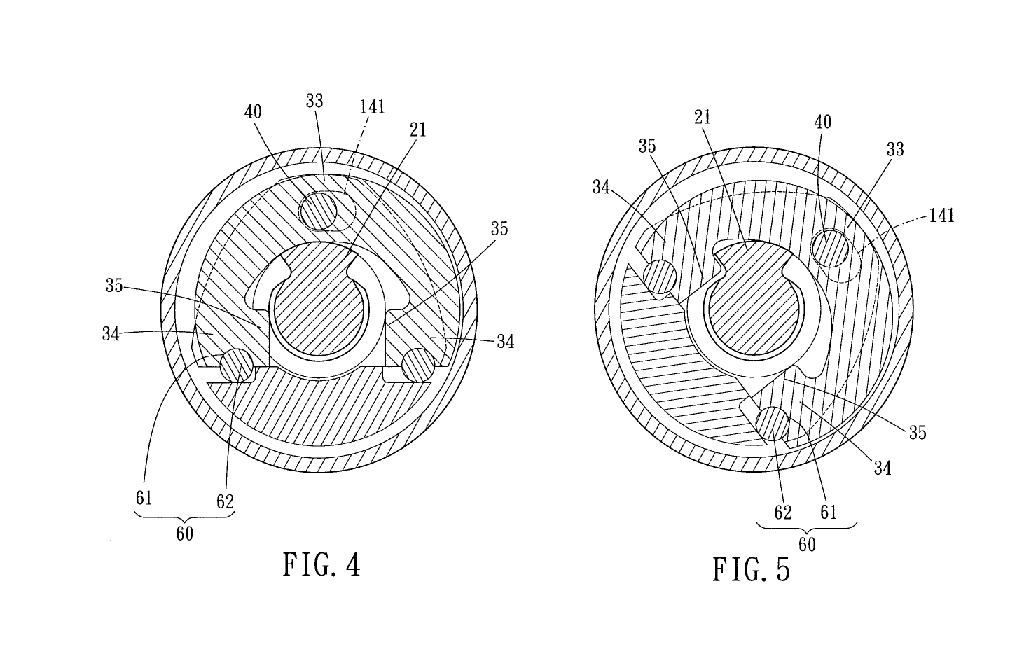

Please refer to FIGS. 1 to 4 for a preferred embodiment of the present invention. A hammer assembly 1 of a power tool includes a main body 10, an axle 20 and a hammer block 30.

The main body 10 defines an axial direction 11 and a radial direction 12, the main body 10 has a receiving room 13 opened radially and has two saddle portions 14 by two opposite sides of the receiving room 13 in the axial direction 11, and the two saddle portions 14 respectively have an assembling end 15 (for example, a key slot) for being connected to a power source of a power tool (for example, a pneumatic or electric tool) and a through hole 16 communicating with the receiving room 13 in the axial direction 11. The axle 20 is disposed through the through hole 16 axially into the receiving room 13 and rotatably assembled to the main body 10. The hammer block 30 is laterally movably and circumferentially swingably assembled to the main body 10, and the hammer block 30 is received in the receiving room 13 and swingably saddled around the axle 20. When the main body 10 is driven by the power source to rotate, the hammer block 30 comoves with the main body 10 and impacts and drives the axle 20 intermittently. The hammer assembly 1 of a power tool may be received in a shell body 50 of the power tool. It is understandable that the hammer assembly of a power tool may include plural sets of the hammer blocks.

Specifically, a distal end of each said saddle portion 14 has a sliding slot 141 extending laterally relative to the axial direction 11, the two sliding slots 141 are arranged opposite to each other in the axial direction 11, two opposite sides of the hammer block 30 respectively include a pin portion 41 inserted into one of the two sliding slots 141, through the two pin portions 41 slidably inserted in one of the two sliding slots 141, and the hammer block 30 is laterally movable along the sliding slot 141 and circumferentially swingable about the two pin portions 41. The two sliding slots 141 can restrict a lateral moving distance of the hammer block 30. In this embodiment, the two opposite sides of the hammer block 30 respectively have a receiving hole 31, each said pin portion 41 is inserted in the receiving hole 31, specifically, the two receiving holes 31 are axially communicated with each other to form a pin hole penetrating through the hammer block 30, two ends of a pin member 40 are provided with the two pin portions 41, and the pin member 40 is disposed through the pin hole. However, the pin portion may be integrally formed on the hammer block, a spring-apex pin structure or other similar structures; a distal end of each said saddle portion may further has a through slot communicating with the sliding slot, the pin portion connected to the hammer block may pass through the through slot directly and be arranged in the sliding slot, and a shell body of the power tool may cover the through slot and positionably restrict the pin portion. The sliding slot and the receiving hole may be interchanged to be disposed on the hammer block and the main body.

The receiving room 13 has a bottom portion 131, the bottom portion 131 includes an arc face 132 with the axial direction 11 as an axis of the arc face 132 and two abutting faces 133 by two opposite sides of the arc face 132 (the arc face may be a plan face or an arc face), the arc face 132 and respective one of the two abutting faces 133 have an abutting shoulder 134 therebetween, and each said abutting shoulder 134 is circumferentially interferable with the hammer block 30. Te hammer block 30 includes two abutting mechanisms 60 opposite to the two abutting faces 133, and each said abutting mechanism 60 slidably abuts against one of the abutting faces 133 and is circumferentially interferable with the abutting shoulder 134. The abutting mechanism 60 includes a recess 61 on the hammer block 30 and facing the abutting face 133 and a rolling member 62 received in the recess 61, the recess 61 and the rolling member 62 may respectively be an axial long slot and a rolling column, the two rolling columns may largely decrease an abrasion, and through the two rolling columns and the two abutting shoulders 134 abutting against each other, a swinging range of the hammer block 30 is restrictable so as to prevent the hammer block from impacting the axle 20 and being damaged.

Preferably, the main body 10 has a first outer arc face 17 opposite to the receiving room 13, the hammer block 30 has a second outer arc face 32 opposite to the receiving room 13, and the first and second outer arc faces 17, 32 are substantially located on a same circumscribed circle. Specifically, the first outer arc face 17 is a minor arc face, and the second outer arc face 32 is a major arc face. As viewed along the axial direction 11, the saddle portion 14 is tapered from the first outer arc face 17 toward the sliding slot 141, the main body 10 is substantially teardrop-shaped, the hammer block 30 is substantially C-shaped, and with this structure, a torque of the hammer block 30 can be increased and the dynamic balance of the hammer assembly 1 of the power tool in rotation can be elevated. Specifically, the hammer block 30 has a body arc section 33 assembled to the main body 10 and two end arc sections 34 which are respectively connected to two ends of the body arc section 33, the two end arc sections 34 are located by two opposite sides of the axle 20, and as viewed along the radial direction 12, the end arc section 34 is narrower than the body arc section 33. An impacted block 21 protrudes radially from the axle 20, each said end arc section 34 has an impacting block 35 protruding toward the axle 20, and the impacted block 21 is located on a swinging path of each said impacting block 35 and is impacted by the impacting block 35 of the hammer block 30 intermittently so as to make the axle 20 to rotate and export power intermittently. The end arc section 34 is narrower than the body arc section 33 and is complementary to the impacting block 35 protruding toward the axle 20 in weight so as to elevate the dynamic balance of the hammer assembly 1 of the power tool in rotation.

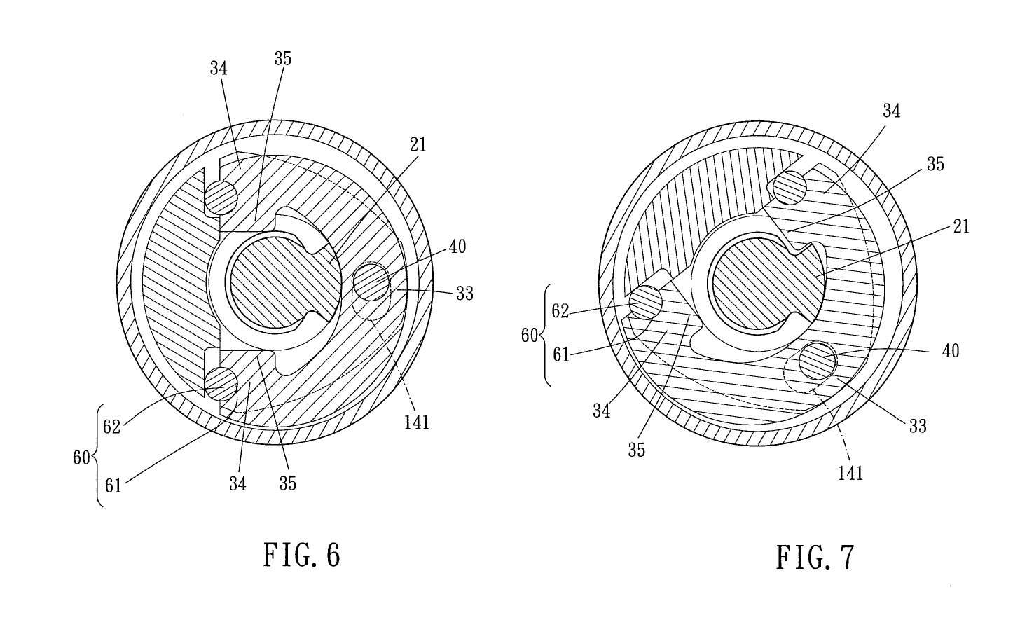

Please refer to FIGS. 5 to 7 for the preset invention in actual operation. The power source rotates the main body 10 and comoves the hammer block 30, the hammer block 30 is rotated to impact one of the impacted blocks 21 of the axle 20 with one of the impacting block 35, after the impacted block 21 is impacted, the impacted block 21 drives the axle 20 to rotate in an angle and the hammer block 30 moves laterally along the two sliding slots 141, the impacted block 21 moves away from the impacting block 35, and the impacting block 35 which rotates continuously can impact the impacted block 21 continuously so as to make the axle 20 rotate and export power intermittently. The two sliding slots 141 allow the hammer block 30 to move laterally and prevent the hammer block 30 from impacting the main body 10 heavily directly when the hammer block 30 is impacted; therefore, the imbalance situation during impacting or flinging can be largely decreased so as to achieve a preferable dynamic balance and rotational balance and to increase a precision and a duration of the operation.

In addition, the hammer assembly of the power tool has a simple structure, so it is easy to be assembled or disassembled. Preferably, the structures of the main body and the hammer block can be designed according to the structure of each other so as to elevate the dynamic balance of the hammer assembly of the power tool in rotation.

While we have shown and described various embodiments in accordance with the present invention, it should be clear to those skilled in the art that further embodiments may be made without departing from the scope of the present invention.

What is claimed is:

1. A hammer assembly of a power tool, including:
a main body, defining an axial direction and a radial direction, the main body having a receiving room opened radially and having two saddle portions by two opposite sides of the receiving room in the axial direction, the two saddle portions respectively having an assembling end for being connected to a power source of a power tool and a through hole communicating with the receiving room in the axial direction;
an axle, disposed through the through hole axially into the receiving room and rotatably assembled to the main body;
a hammer block, laterally movably and circumferentially swingably assembled to the main body, the hammer block received in the receiving room and swingably saddled around the axle;
wherein when the main body is driven by the power source to rotate, the hammer block comoves with the main body and impacts and drives the axle intermittently.

2. The hammer assembly of a power tool of claim 1, wherein each said saddle portion has a sliding slot extending laterally relative to the axial direction, the two sliding slots are opposite to each other in the axial direction, two opposite sides of the hammer block respectively include a pin portion inserted into one of the two sliding slots, and through the two pin portions slidably inserted in one of the two sliding slots, the hammer block is laterally movable along the sliding slot and circumferentially swingable about the two pin portions.

3. The hammer assembly of a power tool of claim 2, wherein the two opposite sides of the hammer block respectively have a receiving hole, each said pin portion is inserted in the receiving hole, the two receiving holes are axially communicated with each other to form a pin hole penetrating through the hammer block, two ends of a pin member are provided with the two pin portions, and the pin member is disposed through the pin hole.

4. The hammer assembly of a power tool of claim 1, wherein the receiving room has a bottom portion, the bottom portion includes an arc face with the axial direction as an axis of the arc face and two abutting faces by two opposite sides of the arc face, the arc face and respective one of the two abutting faces have an abutting shoulder therebetween, and each said abutting shoulder is circumferentially interferable with the hammer block.

5. The hammer assembly of a power tool of claim 4, wherein the hammer block includes two abutting mechanisms opposite to the two abutting faces, and each said abutting mechanism slidably abuts against one of the abutting faces and is circumferentially interferable with the abutting shoulder.

6. The hammer assembly of a power tool of claim 5, wherein the abutting mechanism includes a recess on the hammer block and a rolling member received in the recess.

7. The hammer assembly of a power tool of claim 1, wherein the main body has a first outer arc face opposite to the receiving room, the hammer block has a second outer arc face opposite to the receiving room, the first and second outer arc faces are substantially located on a same circumscribed circle, the first outer arc face is a minor arc face, and the second outer arc face is a major arc face.

8. The hammer assembly of a power tool of claim 1, wherein as viewed along the axial direction, the main body is substantially teardrop-shaped, and the hammer block is substantially C-shaped.

9. The hammer assembly of a power tool of claim 1, wherein the hammer block has a body arc section assembled to the main body and two end arc sections which are respectively connected to two ends of the body arc section, the two end arc sections are located by two opposite sides of the axle, and as viewed along the radial direction, the end arc section is narrower than the body arc section.

10. The hammer assembly of a power tool of claim 9, wherein an impacted block protrudes radially from the axle, each said end arc section has an impacting block protruding toward the axle, and the impacted block is located on a swinging path of each said impacting block.
